(19) United States
(12) Patent Application Publication
(10) Pub. No.: US 2025/0220735 A1
(43) Pub. Date: Jul. 3, 2025

(54) PACKET DATA CONVERGENCE PROTOCOL ENTITY ESTABLISHMENT APPARATUS AND METHOD, AND PACKET DATA CONVERGENCE PROTOCOL ENTITY INDICATION APPARATUS AND METHOD

(71) Applicant: FUJITSU LIMITED, Kawasaki-shi (JP)

(72) Inventors: Su YI, Beijing (CN); Meiyi JIA, Beijing (CN)

(73) Assignee: FUJITSU LIMITED, Kawasaki-shi (JP)

(21) Appl. No.: 19/085,597

(22) Filed: Mar. 20, 2025

Related U.S. Application Data
(63) Continuation of application No. PCT/CN2022/122906, filed on Sep. 29, 2022.

(51) Int. Cl. H04W 76/10; H04W 28/02

(52) U.S. Cl. CPC H04W 76/10; H04W 28/0268

(57) ABSTRACT

An apparatus, configured in a terminal equipment for packet data convergence protocol (PDCP) entity establishment, includes: processor circuitry configured to map at least one group of Protocol Data Unit (PDU) Sets to at least one data radio bearer; and establish at least one corresponding packet data convergence protocol (PDCP) entity for the at least one data radio bearer, wherein the at least one packet data convergence protocol (PDCP) entity shares first information.

### CROSS-REFERENCE TO RELATED APPLICATION

This application is a continuation application under 35 U.S.C. 111 (a) of International Patent Application PCT/CN2022/122906 filed on Sep. 29, 2022, and designated the U.S., the entire contents of which are incorporated herein by reference.

### TECHNICAL FIELD

Embodiments of the present application relate to the field of communications technology.

### BACKGROUND

In 3GPP standardization progress, the 5th Generation Mobile Communication (5G) technology is studying key issues, solutions and conclusions that support advanced media services, such as High Data Rate Low Latency (HDRLL) service, Augmented Reality (AR)/Virtual Reality (VR)/extended Reality (XR) services and haptic/multimodal communication services.

For example, the extended Reality (XR) is supported in 3GPP services and networks, where XR is a general term of different types of reality, and XR is applied in different areas such as entertainment, healthcare, education.

Virtual Reality (VR) is a rendered version of a released visual and audio scene. When an observer or user moves within an application-defined limit, rendering aims to simulate the visual and auditory sensory stimulation of the real world as naturally as possible. Augmented Reality (AR) refers to providing the user with additional information or artificially generated items or covering the contents on the current environment. Mixed Reality (MR) is an advanced form of AR in which some virtual elements are inserted into a physical scene in order to provide an illusion that these elements are part of the real scene.

Extended reality (XR) refers to all the real and virtual combined environments and human-computer interactions generated by computer technology and wearable devices, including AR, MR, VR and other representative forms and hybrid crossover fields.

It should be noted that, the above introduction to the background is merely for the convenience of clear and complete description of the technical solution of the present application, and for the convenience of understanding of persons skilled in the art. It cannot be regarded that the above technical solution is commonly known to persons skilled in the art just because that the solution has been set forth in the background of the present application.

### SUMMARY

The key issues, solutions and conclusions that 5G technology is studying to support advanced media services have objects of:

### Supporting Enhancements of Multimodal Services:

studying whether and how to enable applications to provide the user with relevant haptic and multimodal data (such as audio, video, and haptic data related to specific time) at similar time, focusing on the need for enhanced policy control (for example, QoS policy coordination).

### Enhancing Network Exposure to Support Interaction Between 5GS and Applications:

studying whether and how to implement application synchronization and QoS policy coordination between a plurality of user equipments (UEs) or a plurality of Quality of Service (QOS) flows per UE, and how to perform interaction between an application function (AF) and a 5G system (5GS);
studying the exposure of QoS information (such as QoS capabilities) and network conditions of 5GS to applications for fast codec/rate adaptation, which may help provide the required Quality of Experience (QoE) (such as helping to alleviate 5GS congestion).

### Studying Whether and how to Implement the Following QoS and Policy Enhancements for XR Service and Media Service Transport:

studying traffic characteristics of media services that are capable of improving network resource usage and QoE;
enhancing a QoS framework to support Protocol Data Unit (PDU) Set granularity (e.g. video/audio frames/tiles, application data units, control information), where a PDU Set consists of PDUs with the same QoS requirements;
supporting differentiated QoS processing in consideration of different importance of the PDU Set. For example, packets belonging to less important PDU sets are legally discarded to reduce resource waste;
whether and how to support uplink-downlink transport coordination to meet the Round-Trip Time (RTT) delay requirements between the UE and N6 interface (an interface between User Plane Function (UPF) and Data Network (DN)) endpoints for the UPF;
potential policy enhancements to minimize jitter, with a focus on demand provisioning from AF (Application Function), extension of policy and charging control (PCC) rules.

The inventor has found that in order to support the XR service, the existing QoS model based on QoS flow is not able to support the different QoS requirements of the PDU Set.

The PDU Set consists of one or more Protocol Data Units (PDUs) that carry the payload of an information unit generated at the application layer (for example, frames or video slices for XR and media services). In addition, the PDU Set has different QoS requirements, such as priority, and importance.

The existing QoS model based on QoS flow is not able to support different QoS requirements of the PDU Set. Specifically, there are two requirements for PDU Set processing: PDU Set integrated packet processing and PDU Set differentiated processing.

In the current 5GS, the QoS flow is the finest granularity of QOS differentiation in PDU sessions, and 5G QoS characteristics are determined by 5G QOS Identifier (5QI), which means that each packet in the QoS flow is processed according to the same QoS requirement.

The PDU Set integrated packet processing is as follows:

For XR/media services, a set of packets are used to carry the payload of the PDU Set (e.g., frames, video slices/tiles).

At the media layer, the packets in such a PDU Set are decoded/processed as a whole. For example, a frame/video slice may be decoded only if all or a certain number of packets carrying the frame/video slice have been successfully delivered. For example, a client may decode a frame in a group of pictures (GOP) only if it has successfully received all the frames on which the frame depends. Therefore, packet groups in a PDU Set are inherently interdependent in the media layer. If such dependency between the packets in the PDU Set is not taken into account, 5GS may perform scheduling at a low efficiency. For example, 5GS may randomly drop one or more packets, but may try to deliver other packets of the same PDU Set that are useless to the client, thereby wasting radio resources.

### PDU Set Differentiated Processing Refers to:

in view of the high data rate and low latency of XR/media services, the 5GS QoS framework will be enhanced in Rel-18 version to support different QoS processing of the PDU Sets, where the PDU Set may carry different contents, such as I/B/P frames, slices/tiles within I/B/P frames, etc. Therefore, resource waste may be reduced by taking into account different importance of the PDU Sets, for example, differentially treating the packets belonging to less important PDU Sets.

The inventor has found that because QoS flow is not applicable to the same XR/media (XRM) service flow (such as video flow) of different types of PDU Sets with different importance and QoS requirements, it is necessary to implement the PDU Set integrated packet processing and the PDU Set differentiated processing by a method supporting sub QoS flow for XR and media services. However, how to map the sub QoS flow to access network resources and ensure the consistency of the QoS flow is a problem that needs to be solved.

To address at least one of the above problems, provided in embodiments of the present application are a packet data convergence protocol (PDCP) entity establishment apparatus and method, and a PDCP entity indication apparatus and method. At least one sub QoS flow is mapped to a corresponding data radio bearer (DRB), and a corresponding PDCP entity is established for the corresponding DRB, and the corresponding PDCP entity shares first information. In this way, it is possible to perform QoS differentiation on PDU sets having different levels of importance in a QoS flow on the basis of the sub QoS flow, and ensure the consistency of the QoS flow in different PDCP entities.

According to one aspect of embodiments of the present application, a packet data convergence protocol (PDCP) entity establishment method is provided, wherein the method includes:
mapping a QoS flow to at least one DRB, wherein the QoS flow includes at least one sub QoS flow, and the one sub QoS flow corresponds to the one DRB;
establishing at least one corresponding PDCP entity for the at least one DRB, wherein the at least one PDCP entity shares the first information.

According to another aspect of the embodiments of the present application, a packet data convergence protocol (PDCP) entity indication method is provided, wherein the method includes:
transmitting first indication information, wherein the first indication information includes an identity of a QoS flow (QFI) to which a sub QoS flow belongs,
wherein the QoS flow is mapped to at least one DRB, the one QoS flow includes the at least one sub QoS flow, and the one sub QoS flow corresponds to one DRB.

According to another aspect of the embodiments of the present application, there is provided with a packet data convergence protocol (PDCP) entity establishment apparatus, configured in a terminal equipment, the packet data convergence protocol (PDCP) entity establishment apparatus including:
a mapping unit configured to map a QoS flow to at least one data radio bearer, wherein the QoS flow includes at least one QoS flow, and the one QoS flow corresponds to the one data radio bearer; and
an establishing unit configured to establish at least one corresponding packet data convergence protocol (PDCP) entity for the at least one data radio bearer, wherein the at least one packet data convergence protocol (PDCP) entity shares first information.

According to another aspect of the embodiments of the present application, there is provided with a packet data convergence protocol (PDCP) entity indicating apparatus, configured in a network device, wherein the apparatus includes:
a transmitting unit configured to transmit first indication information, wherein the first indication information includes an identity of a QoS flow to which a sub QoS flow belongs,
wherein the QoS flow is mapped to at least one data radio bearer, the one QoS flow includes the at least one sub QoS flow, and the one sub QoS flow corresponds to one data radio bearer.

One of the beneficial effects of the embodiments of the present application includes: at least one sub QoS flow is mapped to a corresponding DRB, and a corresponding PDCP entity is established for the corresponding DRB, and the corresponding PDCP entity shares the first information; thus, it is possible to perform QoS differentiation on PDU sets having different levels of importance in a QoS flow on the basis of the sub QoS flow, and ensure the consistency of the QoS flow in different PDCP entities.

With reference to the specification and drawings below, specific embodiments of the present application are disclosed in detail, which specifies the manner in which the principle of the present application can be adopted. It should be understood that, the scope of the embodiments of the present application is not limited. Within the scope of the spirit and clause of the appended claims, the embodiments of the present application include many variations, modifications and equivalents.

The features described and/or shown for one embodiment can be used in one or more other embodiments in the same or similar manner, can be combined with the features in other embodiments or replace the features in other embodiments.

It should be emphasized that, the term “include/comprise” refers to, when being used in the text, existence of features, parts, steps or assemblies, without exclusion of existence or attachment of one or more other features, parts, steps or assemblies.

### BRIEF DESCRIPTION OF THE DRAWINGS

Elements and features described in one of the drawings or embodiments of the present application may be combined with the elements and features shown in one or more other drawings or embodiments. Moreover, in the drawings, similar reference signs indicate corresponding parts in several drawings and may be used to indicate corresponding parts used in more than one embodiment.

FIG. 1 is a schematic diagram of a system architecture in the embodiments of the present application;

FIG. 2 is a schematic diagram of a packet data convergence protocol (PDCP) entity establishment method in the embodiments of the present application;

FIG. 3 is a schematic diagram showing that at least one sub QoS flow establishes at least one corresponding PDCP entity in the present application;

FIG. 4 is a schematic diagram of a packet data convergence protocol (PDCP) entity indication method in the embodiments of the present application;

FIG. 5 is a schematic diagram of a packet data convergence protocol (PDCP) entity establishment apparatus in the embodiments of the present application;

FIG. 6 is a schematic diagram of a packet data convergence protocol (PDCP) entity indicating apparatus in the embodiments of the present application;

FIG. 7 is a schematic diagram of composition of the network device in the embodiments of the present application;

FIG. 8 is a schematic diagram of a terminal equipment in the embodiments of the present application.

### DETAILED DESCRIPTION

With reference to the drawings, the foregoing and other features of the present application will become apparent through the following specification. The Description and drawings specifically disclose the particular embodiments of the present application, showing part of the embodiments in which the principle of the present application can be adopted, it should be understood that the present application is not limited to the described embodiment, on the contrary, the present application includes all modifications, variations and equivalents that fall within the scope of the appended claims.

In embodiments of the present application, the terms “first”, “second”, etc., are used to distinguish different elements by their appellation, but do not indicate the spatial arrangement or chronological order of these elements, etc., and these elements shall not be limited by the terms. The term “and/or” includes any and all combinations of one or more of the terms listed in association with the term. The terms “contain”, “include”, “have”, etc., refer to the presence of the stated feature, element, component or assembly, but do not exclude the presence or addition of one or more other features, elements, components or assemblies.

In the embodiments of the present application, the singular forms “one”, “the”, etc., including the plural forms, shall be broadly understood as “a sort of” or “a kind of” and not limited to the meaning of “one”; furthermore, the term “said” shall be understood to include both the singular form and the plural form, unless it is expressly indicated otherwise in the context. In addition, the term “according to” should be understood to mean “at least partially according to . . . ”, and the term “based on” should be understood to mean “based at least partially on . . . ”, unless it is expressly indicated otherwise in the context.

In embodiments of the present application, the term “communications network” or “wireless communications network” may refer to a network that complies with any of the following communication standards, such as Long Term Evolution (LTE), Enhanced Long Term Evolution (LTE-A), Wideband Code Division Multiple Access (WCDMA), High-Speed Packet Access (HSPA), etc.

In addition, the communication between the devices in the communication system can be carried out according to the communication protocol of any stage, for example, including but not being limited to 1G (generation), 2G, 2.5G, 2.75G, 3G, 4G, 4.5G and 5G, New Radio (NR), etc., and/or other communication protocols currently known or to be developed in the future.

In the embodiments of the present application, the term “network device” refers to, for example, a device in the communication system that connects a terminal equipment to the communication network and provides services to the terminal equipment. The network device may include but is not limited to: a base station (BS), an access point (AP), a transmission reception point (TRP), a broadcast transmitter, a mobile management entity (MME), a gateway, a server, a radio network controller (RNC), a base station controller (BSC), etc.

The base station may include, but is not limited to, a node B (NodeB or NB), an evolution node B (eNodeB or eNB), 5G base station (gNB), etc., and may also include a remote radio head (RRH), a remote radio unit (RRU), a relay, or a low-power node (such as femto, pico, etc.). And the term “base station” may include some or all of their functions, with each base station providing communication coverage to a specific geographic area. The term “cell” can refer to a base station and/or its coverage area, depending on the context in which the term is used.

In the embodiments of the present application, the term “user equipment” (UE) or “terminal equipment or terminal device” (TE) refers, for example, to a device that is connected to the communication network through the network device and receives network services. The terminal equipment can be fixed or movable, and can also be called a mobile station (MS), a terminal, a subscriber station (SS), an access terminal (AT), a station, etc.

The terminal equipment may include but is not limited to: a cellular phone, a personal digital assistant (PDA), a wireless modem, a wireless communication device, a handheld device, a machine-type communication device, a laptop computer, a cordless phone, a smart phone, a smart watch, a digital camera, etc.

For another example, in scenarios such as Internet of Things (IoT), the terminal equipment may also be a machine or an apparatus that performs monitoring or measurement, and may include, but is not limited to, a machine type communication (MTC) terminal, a vehicle communication terminal, a device to device (D2D) terminal, a machine to machine (M2M) terminal, and etc.

In addition, the term “network side” or “network device side” refers to the side of the network, which may be a base station or may include one or more network devices as described above. The term “user side” or “terminal side” or “terminal equipment side” refers to the side of the user or terminal, which may be a UE or may include one or more terminal equipments as described above. Without specifically indicated, “device” can refer to a network device or a terminal equipment.

Hereinafter the scenarios of in the embodiments of the present application are illustrated by examples, but which is not limited in the present application.

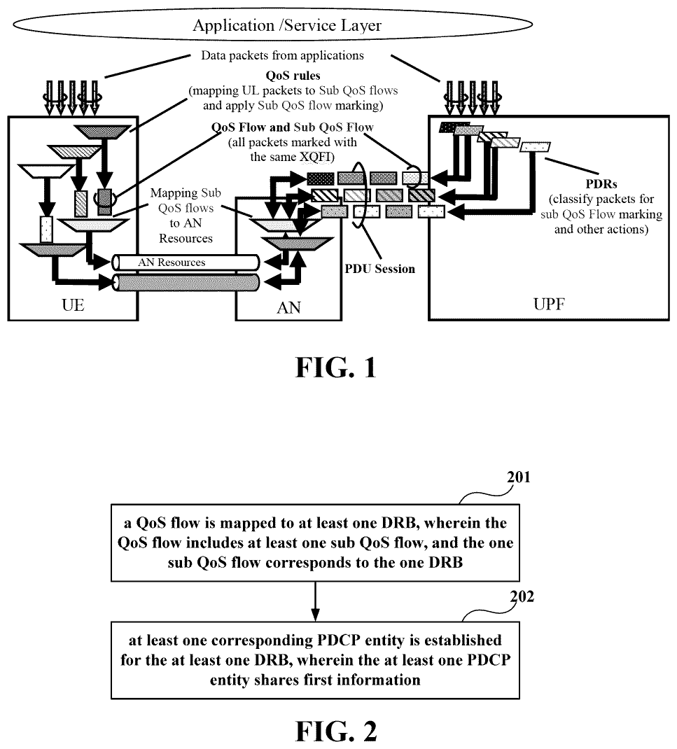

FIG. 1 is a schematic diagram of a system architecture in the embodiments of the present application. For simplicity, FIG. 1 only schematically illustrates classification of QoS flow and sub QoS flow, as well as the principle of user plane labeling and mapping to access network resources.

Because QoS flow is not applicable to the same XR/media (XRM) service flow (such as video flow) of different types of PDU Sets with different importance and QoS requirements, 3GPP proposes to extend the QoS framework based on QoS Flow. A QoS flow contains a plurality of sub QoS flows, wherein different types of PDU Sets belonging to the QoS flows are mapped to different sub QoS flows of related QoS flows. The QoS flow still has a QoS profile, which is named a primary QoS profile. Each sub QoS flow of a QoS flow has its own QoS Profile, called a sub QoS profile.

All the sub QoS profiles and the related primary QoS profiles have the same 5QI, but have different QoS characteristics.

The main features of the QOS architecture based on the sub QoS flows include but are not limited to:

User plane traffic (such as XRM video service flow) consists of different types of PDU Sets.

All PDU Sets of XRM user plane traffic are mapped to the same QoS flow.

The QoS flow consists of a plurality of sub QoS flows, that is, different PDU Sets may be mapped to different sub QoS flows of the QoS flow.

Each sub QoS flow has an XQFI (XR QoS Flow ID) identity, which consists of a QoS flow ID (QFI) and a sub QoS flow ID (SQFI), wherein XQFI (=QFI+SQFI) is unique for each UE, and SQFI is unique in each UE's QoS flow.

XQFI is used for a GTP-U header in N3/N9 GTP-U traffic of XRM PDU Set.

XRM QoS flow is associated with a primary QoS profile and a plurality of sub QoS profiles, each sub QoS flow is associated with a sub QoS profile, wherein the primary QoS profile is used by a QoS flow that does not have any sub QoS flow.

All sub QoS profiles and related primary QoS profiles have the same 5QI, but have different QoS characteristics, that is, each sub QoS flow may have its own priority, maximum data burst, and an average window of the same 5QI;
the UE classifies and labels the uplink user plane traffic based on the QoS rule, that is, the uplink traffic of XRM is associated with the QoS flow and the sub QoS flow.

In this application, the sub QoS flow refers to a set of PDU Sets with similar QoS characteristics. Optionally, the expression of “sub QoS flow” may also be replaced with “a set of PDU Sets with the same importance or priority”, “a PDU family with the same importance or priority” and the like, and correspondingly an identity of the sub QoS flow may be used, the PDU set priority marking or PDU family identity, and the like may also be used. The expression “sub QoS flow” is used uniformly for subsequent description of the present application.

The PDCP layer is used to provide header compression, encryption, integrity protection and other operations for control plane and user plane data, and to provide the UE with lossless switching and data recovery support. The PDCP entity corresponding to the PDCP layer also aims to implement the functions of PDCP sequence number (SN) maintenance, reordering and duplicate discarding. When a transmitting buffer of the PDCP entity is processed, the PDCP sequence number maintenance function ensures the uplink transmission sequence of the QoS flow. When receiving buffer is processed, the reordering function ensures that the downlink data of the QoS flow is delivered in order, and the duplicate discarding ensures that the same redundant data received is not delivered to an upper layer.

In the related art, the transmitting buffer, the receiving buffer, and the corresponding sequence number, reordering, and duplicate discarding functions are based on each PDCP entity. These functions are independent between different PDCP entities, that is, QoS flows mapped to different DRBs.

Therefore, in the QoS architecture based on sub QoS flows, how to map the sub QoS flows to access network resources and how to ensure the consistency of QoS flows corresponding to different PDCP entities are all problems that need to be solved.

Specifically, in the related art, a Service Data Adaptation Protocol (SDAP) sub-layer maps the QoS flow to DRB. If a concept of sub QoS flow is introduced for XRM service, how to map the sub QoS flows to DRB and how to ensure the consistency of QoS flows corresponding to different PDCP entities after mapping the sub QoS flow to DRB are all problems that need to be solved.

To address at least one of the above problems, provided in the embodiments of the present application are a packet data convergence protocol (PDCP) entity establishment apparatus and method, and a PDCP entity indication apparatus and method.

### Embodiments of First Aspect

The embodiments of the present application provide a packet data convergence protocol (PDCP) entity establishment method.

FIG. 2 is a schematic diagram of a packet data convergence protocol (PDCP) entity establishment method in the embodiments of the present application, as shown in FIG. 2, the method including:
201: a QoS flow is mapped to at least one DRB, wherein the QoS flow includes at least one sub QoS flow, and the one sub QoS flow corresponds to the one DRB;
202: at least one corresponding PDCP entity is established for the at least one DRB, wherein the at least one PDCP entity shares the first information.

In this way, it is possible to perform QoS differentiation on PDU sets having different levels of importance in a QoS flow on the basis of the sub QoS flow, and ensure the consistency of the QoS flow in different PDCP entities.

It is worth noting that FIG. 2 above only schematically illustrates the embodiments of the present application, taking a terminal equipment as an example, but the present application is not limited to this. For example, the order of execution between operations may be adjusted appropriately, and some other operations may be added or one or more operations may be removed. In addition, the objects of the above operations can also be adjusted. Those skilled in the art may make appropriate variations in accordance with the above contents, and which is not limited to the disclosure of FIG. 2 above.

In some embodiments, the first information includes at least one of: a transmitting buffer and a sequence number; a receiving buffer, reordering and duplicate discarding; a first timer (t-Reordering); a reception state variable; or a transmission state variable.

In some embodiments, a PDCP entity includes a receiving PDCP entity and a transmitting PDCP entity.

For example, the PDCP layer is used to provide header compression, encryption, integrity protection and other operations for control plane and user plane data, and to provide the UE with lossless switching and data recovery support. The PDCP entity corresponding to the PDCP layer also aims to implement the functions of PDCP sequence number (SN) maintenance, reordering and duplicate discarding. For example, the first timer is the timer t-Reordering of the PDCP layer. The specific contents of the transmitting buffer and sequence number, the receiving buffer, the reordering, and the duplicate discarding may be seen by referring to the related art, and there is no limitation in this application. The reception state variable and the transmission state variable are described in detail in the following.

For example, sharing the above first information may be broadly understood as sharing the maintenance for “transmitting buffer and sequence number”; sharing the above first information may also be broadly understood as sharing the functions of “receiving buffer and reordering and duplicate discarding”; sharing the above first information may also be broadly understood as sharing the “first timer”.

In some embodiments, after the sub QoS flow is mapped to the corresponding DRB, a QoS flow containing at least one sub QoS flow may be mapped to a different DRB, that is, to a different PDCP entity.

In order to ensure the transmission order, reordering, and duplicate discarding requirements of the QoS flow, the transmitting buffer, the receiving buffer and corresponding sequence number, reordering, and duplicate discarding of a plurality of PDCP entities corresponding to one QoS flow may be shared.

Therefore, by the PDCP entities sharing the first information, it is possible to ensure the PDCP sequence number maintenance function of different PDCP entities for the same QoS flow, so as to ensure the uplink transmission order of the QoS flow; and it is possible to ensure the reordering function of different PDCP entities of the same QoS flow when the receiving buffer is processed, ensuring that the downlink data of the QoS flow is submitted in order, ensuring the duplicate discarding function of different PDCP entities of the same QoS flow when the receiving buffer is processed, and ensuring that the same redundant data received is not delivered to an upper layer.

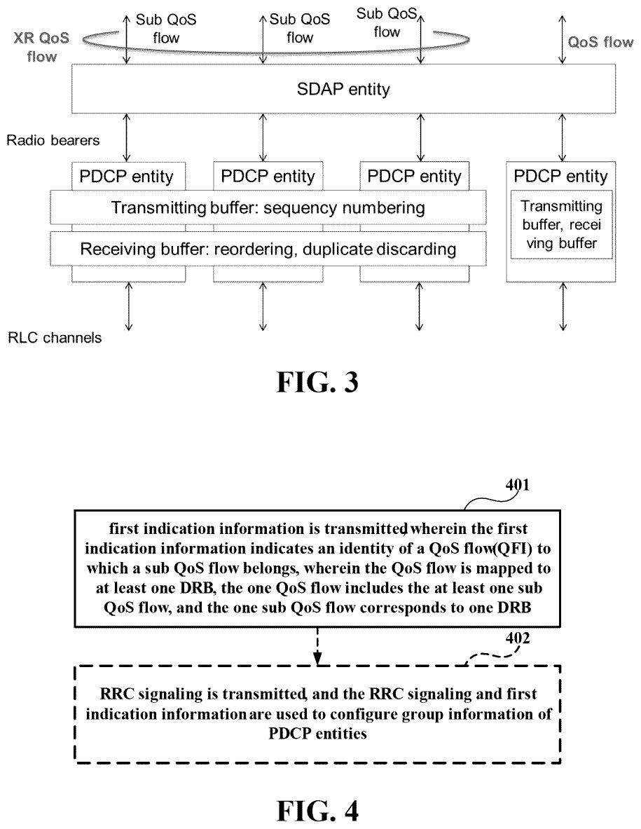

FIG. 3 is a schematic diagram showing that at least one sub QoS flow establishes at least one corresponding PDCP entity in the present application. In some embodiments, as shown in FIG. 3, wherein one or more sub QoS flows may be mapped to one or more corresponding DRBs, wherein one DRB corresponds to one packet data convergence protocol (PDCP) entity, for example, one or more sub QoS flows belong to the same QoS flow. In some embodiments, as shown in FIG. 3, one sub QoS flow may be mapped only to one DRB at a time. In some embodiments, as shown in FIG. 3, if a QoS flow does not contain sub QoS flows, the QoS flow is mapped to DRB, and for example by referring to the related art, a QoS flow is mapped to a DRB. Thus, the system architecture that supports sub QoS flows may be compatible with the system architecture that supports QoS flows. In addition, as shown in FIG. 3, the three sub QoS flows correspond to three PDCP entities respectively, and three transmitting PDCP entities may share the same transmitting buffer, and three receiving PDCP entities may share the same receiving buffer.

In some embodiments, the first information corresponding to the QoS flow is determined according to the first indication information, wherein the first indication information includes a QoS Flow Identity (QFI) to which at least one sub QoS flow belongs.

In some embodiments, a QoS flow correspondingly has a transmission state variable and a reception state variable. For example, the transmission state variable and the reception state variable corresponding to a QoS flow may be determined according to the first indication information.

For example, taking FIG. 3 as an example, three transmitting PDCP entities corresponding to the sub QoS flow in FIG. 3 share the same sequence number pool, the sequence numbers of the three transmitting PDCP entities are generated by a generator, and the three transmitting PDCP entities maintain the same transmission state variable, which is denoted for example by TX_ as a prefix. Three receiving PDCP entities corresponding to the sub QoS flow shown in FIG. 3 maintain the same reception state variable, which is denoted for example by RX_ as a prefix. For example, maintaining the same variable means that the use domain of these variables is in the PDCP entity corresponding to the DRB belonging to the same QoS flow. For example, the three transmitting PDCP entities corresponding to the sub QoS flow shown in FIG. 3 maintain the same first timer t-Reordering, indicating that the reordering function is performed as a whole in the three receiving PDCP entities.

For example, the reception state variable and the transmission state variable are newly defined super variables that are jointly maintained by the PDCP entities corresponding to the DRB to which the sub QoS flows belonging to the same QoS flow are mapped.

Hereinafter the transmission state variable corresponding to a QoS flow is described.

In some embodiments, the transmission state variable corresponding to a QoS flow includes a first transmission state variable, which indicates the COUNT value of the next PDCP SDU to be transmitted in at least one PDCP entity. In some embodiments, at least one PDCP entity associates the COUNT value of the PDCP SDU to this first transmission state variable.

For example, the first transmission state variable maintained by one or more transmitting PDCP entities corresponding to the sub QoS flows (mapped DRBs) belonging to the same QoS flow is named as TX_NEXT_H, which indicates the COUNT value of the next PDCP Service Data Unit (SDU) to be transmitted in these PDCP entities corresponding to the same QoS flow. This variable may also be represented by variable name+index, for example, TX_NEXT (i), where i may be a group index assigned to these PDCP entities corresponding to the same QoS flow, wherein a group index corresponds to a PDCP entity group. For example, the QoS flow is used as the standard for dividing the PDCP entity group, and the group index is a QoS Flow Identity (QFI) to which the sub QoS flow belongs. For example, TX_NEXT (qfi) indicates the COUNT value of the next PDCP Service Data Unit (SDU) to be transmitted in one or more PDCP entities corresponding to sub QoS flow(s) with a QoS ID being qfi, where, wherein the COUNT value is combination of a local superframe number and a PDCP sequence number. The specific content of the COUNT value may be seen by referring to the related art, and there is no limitation in this application.

Optionally, the above first transmission state variable and its corresponding name are for illustrative purpose only, and other transmission variables may also be defined and indicated by other names, and there is no limitation in this application.

Hereinafter the reception state variable corresponding to a QoS flow is described.

In some embodiments, the reception state variable corresponding to a QoS flow includes: a first reception state variable which indicates a COUNT value of next PDCP Service Data Unit (SDU) expected to be received in at least one PDCP entity; and/or a second reception state variable which indicates a COUNT value of the first PDCP SDU of at least one PDCP entity that has not been delivered to the upper layer but is still awaiting transmission; and/or a third reception state variable which indicates next COUNT value of the COUNT value associated with the PDCP data PDU in at least one PDCP entity that triggers a first timer t-Reordering corresponding to a QoS flow.

Hereinafter the reception state variable is illustrated using a method similar to the above “variable name (qfi)”.

For example, one or more receiving PDCP entities corresponding to the sub QoS flows (mapped DRBs) belonging to a QoS flow whose QoS flow ID is qfi maintain the following state variables:
the first reception state variable is named as RX_NEXT (qfi), which indicates the COUNT value of the next PDCP SDU expected to be received in one or more PDCP entities corresponding to the sub QoS flow whose QoS flow ID is qfi;
the second reception state variable is named as RX_DELIV (qfi), which indicates the COUNT value of the first PDCP SDU of one or more PDCP entities corresponding to the sub QoS flow whose QoS flow ID is qfi, that has not been delivered to the upper layer but is still awaiting transmission;
the third reception state variable is named as RX_REORD (qfi), which indicates the next COUNT value of the COUNT value associated with the PDCP data Protocol Data Unit (PDU) in one or more PDCP entities corresponding to the sub QoS flow whose QoS flow ID is qfi, that triggers a t-Reordering (qfi) timer.

In some embodiments, at least one PDCP entity runs the same first timer (t-Reordering) at the same moment.

For example, one or more receiving PDCP entities corresponding to the sub QoS flows (mapped DRBs) belonging to a QoS flow whose QoS flow ID is qfi maintain the following first timer:

the first timer, named as t-Reordering (qfi), is configured by Radio Resource Control (RRC) signaling to detect loss of the PDCP data PDU. When the t-Reordering (qfi) is running, it cannot be turned on again, that is, these receiving PDCP entities may run only one t-Reordering (qfi) at the same moment.

In some embodiments, in order to achieve that the PDCP entities share the first information, the operation process of the PDCP entities needs to be enhanced, which is described in detail below.

In some embodiments, the PDCP data PDU corresponding to the PDCP SDU is encrypted using the first transmission state variable; the sequence number of the PDCP data PDU is set to be modulo division of the first transmission state variable by 2\hat{ }[pdcp-SN-SizeUL], wherein pdcp-SN-SizeUL indicates the bit length of the sequence number; and the value of the first transmission state variable is incremented by one.

For example, in order to realize collaboration/sharing among the PDCP entities, these PDCP entities need to configure a common identity, which may be a group index assigned to these PDCP entities corresponding to the same QoS flow, for example, the group index is the corresponding QoS flow identity QFI; wherein the configuration of the PDCP entities will be described in detail later.

Hereinafter an example is given that a common QoS flow identity needs to be configured for the PDCP entities, assuming that the configuration variable is qfi.

For example, for the transmitting operation of the PDCP layer, there are the following enhancements:

for the PDCP SDU received from the upper layer, the transmitting PDCP entity needs to execute the following steps:

If this PDCP entity is configured with qfi (the PDCP entity is related to sub QoS flows), the COUNT value of this PDCP SDU is associated with TX_NEXT (qfi) (the sequence number of this PDCP entity uses a shared sequence number).

If the PDCP entity is configured with qfi, after uplink data compression is performed, integrity protection is implemented and TX_NEXT (qfi) is used for encryption; then, the PDCP sequence number of the PDCP data PDU is set as TX_NEXT (qfi) modulo 2^{[pdep-SN-SizeUL]}, and then the value of TX_NEXT (qfi) is incremented by one; wherein modulo refers to modulus, modulo division, that is, Mod; pdcp-SN-SizeUL refers to the bit length of uplink PDCP sequence number.

Hereinafter is an example of protocol enhancements for TS38.323:

```
For a PDCP SDU received from upper layers, the transmitting PDCP entity shall:
  - if this PDCP entity is configured with a qfi,
        -associate the COUNT value corresponding to TX_NEXT(qfi) to this PDCP SDU;
  - else,
          - associate the COUNT value corresponding to TX_NEXT to this PDCP SDU;
  as specified in the clause 5.12.4;
  - perform uplink data compression of the PDCP SDU as specified in clause 5.14.4;
  - if this PDCP entity is configured with a qfi,
      - perform integrity protection, and ciphering using the TX_NEXT(qfi) as specified in
    the clause 5.9 and 5.8, respectively;
      - set the PDCP SN of the PDCP Data PDU to TX_NEXT(qfi) modulo 2 ^{[}^{pdcp-SN-SizeUL ]};
      - increment TX_NEXT(qfi) by one;
  - else,
  - perform integrity protection, and ciphering using the TX_NEXT as specified in the
    clause 5.9 and 5.8, respectively;
  - set the PDCP SN of the PDCP Data PDU to TX_NEXT modulo 2^{[pdcp-SN-SizeUL]};
  - increment TX_NEXT by one;
  - submit the resulting PDCP Data PDU to lower layer as specified below.
...
```

Since the PDCP entity corresponding to the sub QoS flow uses information such as the shared state variable and the first timer, the processes such as initialization and reset of the shared state variable and the first timer also need to be enhanced, as explained in detail below.

In some embodiments, establishing at least one corresponding PDCP entity for at least one DRB includes at least one of the following: the upper layer requests the PDCP entity to be established; the upper layer requests the PDCP entity to be re-established; or the upper layer requests the PDCP entity to be suspended.

In some embodiments, where establishing at least one corresponding PDCP entity for at least one DRB includes that the upper layer requests the PDCP entity to be established, in the case where at least one PDCP entity establishes a first PDCP entity for the QoS flow, the transmission state variable and the reception state variable of the first PDCP entity are set to initial values.

For example, the following enhancements are made during the establishment of the PDCP entity:

when the upper layer requests to establish a PDCP entity of a radio bearer, UE needs to first establish a PDCP entity for the radio bearer. If the PDCP entity (or the radio bearer) corresponds to a sub QoS flow, and the PDCP entity is the first PDCP entity established for the QoS flow to which the sub QoS flow belongs, then the transmission state variable and the reception state variable of the PDCP entity are set to the initial values.

In some embodiments, where establishing at least one corresponding PDCP entity for at least one DRB includes that the upper layer requests the PDCP entity to be re-established:

For DRB in an unacknowledged Mode, in the case where the DRB in the unacknowledged Mode is a unique DRB of the QoS flow, the transmission state variable and/or a first reception state variable and/or a second reception state variable to which the QoS flow corresponds is/are set to be of an initial value/initial values; and/or in the case where the first timer (t-Reordering) to which the QoS flow corresponds is running and where the DRB in the unacknowledged mode is a unique DRB of the QoS flow, the first timer (t-Reordering) to which the QoS flow corresponds is stopped and reset.

The following enhancements are made during the re-establishment of the PDCP entity:

When the upper layer requests the PDCP entity to be re-established, the transmitting PDCP entity needs to execute the following operations:

for the DRB in the UM (Unacknowledged Mode), if it is for a sub QoS flow, and the DRB is the unique DRB of the QoS flow to which the sub QoS flow belongs (no other PDCP entity is configured with the same qfi as the PDCP entity), then the first transmission state variable TX_NEXT (qfi) is set to be of an initial value.

When the upper layer requests the PDCP entity to be re-established, the receiving PDCP entity needs to execute the following operations:

For the DRB in UM, if the first timer t-Reordering (qfi) is running and this DRB is the unique DRB of the QoS flow to which the sub QoS flow belongs, the first timer t-Reordering (qfi) is stopped and reset.

For the DRB in UM, if this DRB is the unique DRB of the QoS flow to which the sub QoS flow belongs, the first reception state variable RX_NEXT (qfi) and the second reception state variable RX_DELIV (qfi) are set to be of initial values.

In some embodiments, where establishing at least one corresponding PDCP entity for at least one DRB includes that the upper layer requests the PDCP entity to be suspended:

In the case where the at least one PDCP entity has only one PDCP entity or where all of the at least one PDCP entity is suspended, the transmission state variable and/or the first reception state variable and/or the second reception state variable to which the QoS flow corresponds is/are set to be of an initial value/initial values; and/or in the case where the first timer (t-Reordering) to which the QoS flow corresponds is running and where the at least one PDCP entity has only one PDCP entity, the first timer (t-Reordering) to which the QoS flow corresponds is stopped and reset.

For example, the following enhancements are made during the suspension of the PDCP entity:
when the upper layer requests the PDCP entity to be suspended, the transmitting PDCP entity needs to execute the following operations:
if no other PDCP entity is configured with the same qfi as the PDCP entity, or all other PDCP entities configured with the same qfi as the PDCP entity are suspended, the first transmission state variable TX_NEXT (qfi) is set to be of an initial value.

When the upper layer requests the PDCP entity to be suspended, the reception PDCP entity needs to execute the following operations:
if the first timer t-Reordering (qfi) is running and no other PDCP entity is configured with the same qfi as the PDCP entity, the first timer t-Reordering (qfi) is stopped and reset.
if and PDCP entity corresponds to the sub QoS flow and no other PDCP entity is configured with the same qfi as the PDCP entity, or all other PDCP entities configured with the same qfi as the PDCP entity are suspended, then the first reception state variable RX_NEXT (qfi) and the second reception state variable RX_DELIV (qfi) are set to be of initial values.

In some embodiments, in order to achieve that the PDCP entities share the first information, the configuration of the PDCP entities needs to be enhanced, which is described in detail below.

In some embodiments, group information of the PDCP entities is configured by using RRC signaling and first indication information. For example, the corresponding QoS flow identity is used as a group index of the group information, and the group information is used for at least one PDCP entity group to share the first information, wherein a first field is newly added to the RRC signaling to indicate the first indication information, in a case where the first field is present, the first information to which the QoS flow corresponds is determined according to the first indication information.

For example, when the PDCP layer is configured by using RRC signaling, the group index of the PDCP entity may be configured, for example, indicating the QoS flow information to which the sub QoS flow belongs, such as QFI.

For example, the IE corresponding to the RRC signaling is “PDCP-Config” IE, wherein “PDCP-Config” IE is used to configure configurable PDCP parameters for the radio bearer.

For example, a field is added to the “PDcp-config” IE to identify the PDCP entity group. For example, this field indicates the group index, for example, indicates the QoS flow information to which the sub QoS flow belongs, for example, qfi. This field is optional. If the field exists, it indicates that the PDCP entity corresponds to a sub QoS flow, and the QoS flow ID of the sub QoS flow is qfi.

Hereinafter is an example of protocol (PDCP-Config IE) enhancement for TS38.331:

| | |
|---|---|
| PDCP-Config ::= | SEQUENCE { |
| drb | SEQUENCE { |
| discardTimer | ENUMERATED {ms10, ms20, ms30, ms40, ms50, |

ms60, ms75, ms100, ms150, ms200, ms250, ms300, ms500, ms750, ms1500, infinity}
OPTIONAL, -- Cond Setup

| | |
|---|---|
| pdcp-SN-SizeUL | ENUMERATED {len12bits, len18bits} |

OPTIONAL, -- Cond Setup2

| | |
|---|---|
| pdcp-SN-SizeDL | ENUMERATED {len12bits, len18bits} |

OPTIONAL, -- Cond Setup2
...}

| | |
|---|---|
| qfi | QFI OPTIONAL, -- Need N |

}

| | |
|---|---|
| QFI ::= | INTEGER (0..maxQFI) |

In some embodiments, the RRC signaling is further used to configure second information corresponding to the first indication information; wherein the second information includes an initial value of the first timer (t-Reordering) and/or a bit length of the sequence number, wherein the RRC signaling is used to configure the identical second information for the at least one PDCP entity.

For example, the “PDCP-Config” IE also indicates the second information about the configuration of the transmitting buffer and receiving buffer functions, such as the initial value of the first timer (t-Reordering) and a parameter value of the bit length of the sequence number (pdcp-SN-SizeUL, pdcp-SN-SizeDL), wherein the second information is configured for each PDCP entity; if sub QoS flows are mapped to DRBs, these configurations need to be consistent in the PDCP entity group. For example, implementation by the network side, that is, the network implementation needs to ensure that parameter values having no conflict are configured for the PDCP-Configs with the same qfi.

In some embodiments, at least one corresponding PDCP entity is established for the at least one DRB in a newly added first sublayer, wherein the first sublayer contains the first information.

For example, on the PDCP entity, a new sublayer or a new super PDCP entity, or a new control module is established, to manage buffers and associated state variables and timers of one or more PDCP entities (that is, the PDCP entity group, for example, grouped by the identity information of the QoS flow they belong to). The transmitting buffer, the receiving buffer and the corresponding sequence number maintenance, reordering and duplicate discarding functions in the existing PDCP entity are transferred to the new module.

The embodiments above only schematically illustrate the embodiments of the present application, but the present application is not limited to this, and appropriate variations may also be made on the basis of the above embodiments. For example, the above embodiments may be used separately, or one or more of the above embodiments may be combined.

It can be seen from the above embodiments that the sub QoS flow can be mapped to the corresponding DRB, thus supporting QOS differentiation between PDU Sets of different importance in the QoS flow, further improving the efficiency in scheduling and packet loss processing, and reducing the waste of resources.

### Embodiments of Second Aspect

The embodiments of the present application provide a packet data convergence protocol (PDCP) entity indication method, applied to the side of a network device. The embodiments of the present application may be combined with the embodiments of the first aspect or may be implemented separately. The same content as that is in the embodiments of the first aspect is not repeated.

FIG. 4 is a schematic diagram of a packet data convergence protocol (PDCP) entity indication method in the embodiments of the present application, as shown in FIG. 4, the method including:

401: first indication information is transmitted, wherein the first indication information indicates an identity of a QoS flow (QFI) to which a sub QoS flow belongs, wherein the QoS flow is mapped to at least one DRB, the one QoS flow includes the at least one sub QoS flow, and the one sub QoS flow corresponds to one DRB.

In some embodiments, as shown in FIG. 4, the method further includes:

402: RRC signaling is transmitted, and RRC signaling and the first indication information are used to configure group information of the PDCP entities.

In some embodiments, that RRC signaling and the first indication information is used to configure group information of the PDCP entities includes: newly adding a first field to the RRC signaling to indicate the first indication information, in a case where the first field is present, the first information to which the QoS flow corresponds is determined according to the first indication information.

In some embodiments, the first information includes at least one of: transmitting buffer and sequence number; receiving buffer and reordering, duplicate discarding; a first timer (t-Reordering); a reception state variable; or a transmission state variable.

In some embodiments, the RRC signaling is further used to configure second information corresponding to the first indication information; wherein the second information includes an initial value of the first timer (t-Reordering) and/or a bit length of the sequence number, wherein the RRC signaling is used to configure the identical second information for the at least one PDCP entity.

It is worth noting that FIG. 4 above only schematically illustrates the embodiments of the present application, but the present application is not limited to this. For example, the order of execution between operations may be adjusted appropriately, and some other operations may be added or one or more operations may be removed. Those skilled in the art may make appropriate variations in accordance with the above contents, and which is not limited to the disclosure of FIG. 4 above.

The embodiments above only schematically illustrate the present application, but the present application is not limited to this, and appropriate variations may also be made on the basis of the above embodiments. For example, the above embodiments may be used separately, or one or more of the above embodiments may be combined.

As can be seen from the above embodiments, at least one sub QoS flow is mapped to a corresponding (DRB, and a corresponding PDCP entity is established for the corresponding DRB, and the corresponding PDCP entity shares the first information. In this way, it is possible to perform QoS differentiation on PDU sets having different levels of importance in a QoS flow on the basis of the sub QoS flow, and ensure the consistency of the QoS flow in different PDCP entities.

### Embodiments of Third Aspect

The embodiments of the present application provide a packet data convergence protocol (PDCP) entity establishment apparatus. The apparatus may be, for example, a terminal equipment, or one or more parts or components configured in the terminal equipment, and in addition, the same content as the embodiments of the first aspect will not be repeated.

FIG. 5 is a schematic diagram of a packet data convergence protocol (PDCP) entity establishment apparatus in the embodiments of the present application. As shown in FIG. 5, the packet data convergence protocol (PDCP) entity establishment apparatus 500 includes:
a mapping unit 501 configured to map a QoS flow to at least one data radio bearer, wherein the QoS flow includes at least one QoS flow, and the one QoS flow corresponds to the one data radio bearer; and
an establishing unit 502 configured to establish at least one corresponding packet data convergence protocol (PDCP) entity for the at least one data radio bearer, wherein the at least one packet data convergence protocol (PDCP) entity shares first information.

At least one sub QoS flow is mapped to a corresponding (DRB, and a corresponding PDCP entity is established for the corresponding DRB, and the corresponding PDCP entity shares the first information. In this way, it is possible to perform QoS differentiation on PDU sets having different levels of importance in a QoS flow on the basis of the sub QoS flow, and ensure the consistency of the QoS flow in different PDCP entities.

In some embodiments, wherein the packet data convergence protocol (PDCP) entity includes a receiving packet data convergence protocol (PDCP) entity and a transmitting packet data convergence protocol (PDCP) entity.

In some embodiments, the first information includes at least one of: transmitting buffer and sequence number; receiving buffer and reordering, duplicate discarding; a first timer; a reception state variable; or a transmission state variable.

In some embodiments, wherein the establishing unit 502 is configured to determine the first information to which the QoS flow corresponds according to the first indication information.

In some embodiments, wherein the first indication information includes a QoS flow identity to which at least one sub QoS flow belongs.

In some embodiments, wherein the reception state variable corresponding to a QoS flow includes: a first reception state variable which indicates a COUNT value of next packet data convergence protocol service data unit (PDCP SDU) expected to be received in at least one packet data convergence protocol (PDCP) entity; and/or a second reception state variable which indicates a COUNT value of the first packet data convergence protocol service data unit (PDCP SDU) of the at least one packet data convergence protocol (PDCP) entity that has not been delivered to the upper layer but is still awaiting transmission; and/or a third reception state variable which indicates next COUNT value of the COUNT value associated with the packet data convergence protocol (PDCP) data Protocol Data Unit (PDU) in the at least one packet data convergence protocol (PDCP) entity that triggers the first timer corresponding to the QoS flow.

In some embodiments, wherein the transmission state variable corresponding to a QoS flow includes a first transmission state variable indicating a count value of a packet data convergence protocol service data unit (PDCP SDU) to be transmitted next in the at least one packet data convergence protocol (PDCP) entity.

In some embodiments, wherein the at least one packet data convergence protocol (PDCP) entity associates the count value of the packet data convergence protocol service data unit (PDCP SDU) with the first transmission state variable.

In some embodiments, the packet data convergence protocol (PDCP) entity establishment apparatus 500 further includes: an encrypting unit 503 configured to encrypt the packet data convergence protocol (PDCP) data protocol unit (PDU) to which the packet data convergence protocol service data unit (PDCP SDU) corresponds by using the first transmission state variable, wherein the sequence number of the packet data convergence protocol (PDCP) data protocol unit (PDU) is set to be modulo division of the first transmission state variable by 2\hat{ }[pdcp-SN-SizeUL], where, pdcp-SN-SizeUL is a bit length of the sequence number; and a counting unit 504 configured to add 1 to a value of the first transmission state variable.

In some embodiments, wherein the establishing at least one corresponding data radio bearer for the at least one packet data convergence protocol (PDCP) entity by the establishing unit 502 includes at least one of the following: an upper layer requests the packet data convergence protocol (PDCP) entity to be established; an upper layer requests the packet data convergence protocol (PDCP) entity to be re-established; or, an upper layer requests the packet data convergence protocol (PDCP) entity to be suspended.

In some embodiments, wherein in a case where the establishing at least one corresponding data radio bearer for the at least one packet data convergence protocol (PDCP) entity includes the establishment of an upper layer request packet data convergence protocol (PDCP) entity, in a case where the at least one packet data convergence protocol (PDCP) entity establishes a first packet data convergence protocol (PDCP) entity for the QoS flow, the transmission state variable and the reception state variable of the first packet data convergence protocol (PDCP) entity are set to be of initial values.

In some embodiments, wherein in a case where the establishing at least one corresponding data radio bearer for the at least one packet data convergence protocol (PDCP) entity includes the reestablishment of an upper layer request packet data convergence protocol (PDCP) entity, for a data radio bearer in an unacknowledged mode, in a case where the data radio bearer in the unacknowledged mode is a unique data radio bearer of the QoS flow, the transmission state variable and/or a first reception state variable and/or a second reception state variable to which the QOS flow corresponds is/are set to be of an initial value/initial values; and/or in a case where the first timer to which the QoS flow corresponds is running and the data radio bearer in the unacknowledged mode is a unique data radio bearer of the QoS flow, stopping and resetting the first timer to which the QoS flow corresponds.

In some embodiments, wherein in a case where the establishing at least one corresponding data radio bearer for the at least one packet data convergence protocol (PDCP) entity includes the suspension of an upper layer request packet data convergence protocol (PDCP) entity, in a case where there is only one packet data convergence protocol (PDCP) entity in the at least one packet data convergence protocol (PDCP) entity, or in a case where all the at least one PDCP entity is suspended, the transmission state variable and/or a first reception state variable and/or a second reception state variable to which the QoS flow corresponds is/are set to be of an initial value/initial values; and/or in a case where the first timer to which the QoS flow corresponds is running and there is only one packet data convergence protocol (PDCP) entity in the at least one packet data convergence protocol (PDCP) entity, stopping and resetting the first timer to which the QoS flow corresponds.

In some embodiments, wherein the packet data convergence protocol (PDCP) entity establishment apparatus 500 further includes: a receiving unit 505 configured to receive RRC signaling, wherein the RRC signaling and the first indication information are used to configure group information of the PDCP entity.

In some embodiments, that RRC signaling and the first indication information are used to configure group information of the PDCP entities includes: newly adding a first field to the RRC signaling to indicate the first indication information, in a case where the first field is present, the first information to which the QoS flow corresponds is determined according to the first indication information.

In some embodiments, the RRC signaling is further used to configure second information corresponding to the first indication information; wherein the second information includes an initial value of the first timer and/or a bit length of the sequence number, wherein the RRC signaling is used to configure the identical second information for the at least one packet data convergence protocol (PDCP) entity.

In some embodiments, wherein the at least one packet data convergence protocol (PDCP) entity runs the same first timer at the same time.

In some embodiments, wherein the establishing unit 502 is configured to established at least one corresponding packet data convergence protocol (PDCP) entity for the at least one data radio bearer in a newly added first sublayer, wherein the first sublayer includes the first information.

The embodiments above only schematically illustrate the present application, but the present application is not limited to this, and appropriate variations can also be made on the basis of the above embodiments. For example, the above embodiments may be used separately, or one or more of the above embodiments may be combined.

It is worth noting that only the components or modules related to the present application are illustrated hereinabove, but the present application is not limited to this. The packet data convergence protocol (PDCP) entity establishment apparatus 500 may further include other components or modules, and the details of these components or modules can be seen by referring to the related art.

In addition, for the sake of simplicity, FIG. 5 only exemplarily shows the connection relationship or signal trend between the individual components or modules, but it should be clear to those skilled in the art that various related techniques such as bus connections can be employed. The above individual components or modules can be implemented by hardware facilities such as a processor, a memory, a transmitter, a receiver, etc., which is not limited in the present application.

As can be seen from the above embodiments, at least one sub QoS flow is mapped to a corresponding (DRB, and a corresponding PDCP entity is established for the corresponding DRB, and the corresponding PDCP entity shares the first information. In this way, it is possible to perform QoS differentiation on PDU sets having different levels of importance in a QoS flow on the basis of the sub QoS flow, and ensure the consistency of the QoS flow in different PDCP entities.

### Embodiments of Fourth Aspect

The embodiments of the present application provide a packet data convergence protocol (PDCP) entity indication apparatus. The apparatus may be, for example, a network device, or one or more parts or components configured in the network device, and the same content as the embodiments of the second aspect will not be repeated.

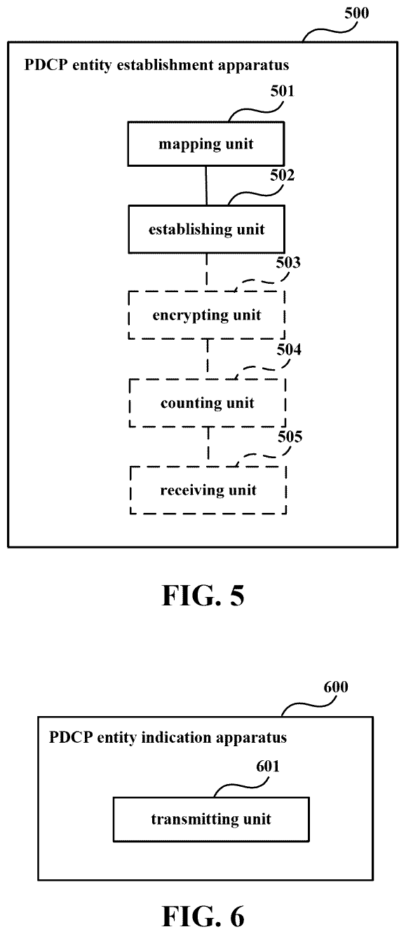

FIG. 6 is a schematic diagram of a packet data convergence protocol (PDCP) entity indication apparatus in the embodiments of the present application. As shown in FIG. 6, a packet data convergence protocol (PDCP) entity indication apparatus 600 includes:

a transmitting unit 601 configured to transmit first indication information, wherein the first indication information indicates an identity of a QoS flow to which a sub QoS flow belongs, wherein the QoS flow is mapped to at least one data radio bearer (DRB), the one QoS flow includes the at least one sub QoS flow, and the one sub QoS flow corresponds to one data radio bearer (DRB).

Therefore, at least one sub QoS flow is mapped to a corresponding (DRB, and a corresponding PDCP entity is established for the corresponding DRB, and the corresponding PDCP entity shares the first information. In this way, it is possible to perform QoS differentiation on PDU sets having different levels of importance in a QoS flow on the basis of the sub QoS flow, and ensure the consistency of the QoS flow in different PDCP entities.

In some embodiments, the transmitting unit 601 is further configured to transmit RRC signaling, and RRC signaling and the first indication information are used to configure group information of the PDCP entities.

In some embodiments, the first information includes at least one of: transmitting buffer and sequence number; receiving buffer and reordering, duplicate discarding; a first timer (t-Reordering); a reception state variable; or a transmission state variable.

In some embodiments, that RRC signaling and the first indication information are used to configure group information of the PDCP entities includes: newly adding a first field to the RRC signaling to indicate the first indication information, in a case where the first field is present, the first information to which the QoS flow corresponds is determined according to the first indication information.

The embodiments above only schematically illustrate the present application, but the present application is not limited to this, and appropriate variations can also be made on the basis of the above embodiments. For example, the above embodiments may be used separately, or one or more of the above embodiments may be combined.

It is worth noting that only the components or modules related to the present application are illustrated hereinabove, but the present application is not limited to this. The packet data convergence protocol (PDCP) entity indication apparatus 600 may further include other components or modules, and the details of these components or modules can be seen by referring to the related art.

In addition, for the sake of simplicity, FIG. 6 only exemplarily shows the connection relationship or signal trend between the individual components or modules, but it should be clear to those skilled in the art that various related techniques such as bus connections can be employed. The above individual components or modules can be implemented by hardware facilities such as a processor, a memory, a transmitter, a receiver, etc., which is not limited in the present application.

As can be seen from the above embodiments, at least one sub QoS flow is mapped to a corresponding (DRB, and a corresponding PDCP entity is established for the corresponding DRB, and the corresponding PDCP entity shares the first information. In this way, it is possible to perform QoS differentiation on PDU sets having different levels of importance in a QoS flow on the basis of the sub QoS flow, and ensure the consistency of the QoS flow in different PDCP entities.

### Embodiments of Fifth Aspect

The embodiments of the present application further provide a communication system, the same content as the embodiments in the first to fourth aspects will not be repeated.

In some embodiments, the communication system may include at least:
a network device configured to transmit first indication information, wherein the first indication information indicates an identity of a QoS flow (QFI) to which a sub QoS flow belongs, wherein the QoS flow is mapped to at least one DRB, the one QoS flow includes the at least one sub QoS flow, and the one sub QoS flow corresponds to one DRB;
a terminal equipment configured to map a QoS flow to at least one DRB, wherein the QoS flow includes at least one sub QoS flow, and the one sub QoS flow corresponds to the one DRB;
the terminal equipment further establishes at least one corresponding PDCP entity for the at least one DRB, wherein the at least one PDCP entity shares the first information.

The embodiments of the present application further provide a network device, which may be, for example, a base station, but which is not limited in the present application, and may also be other network devices.

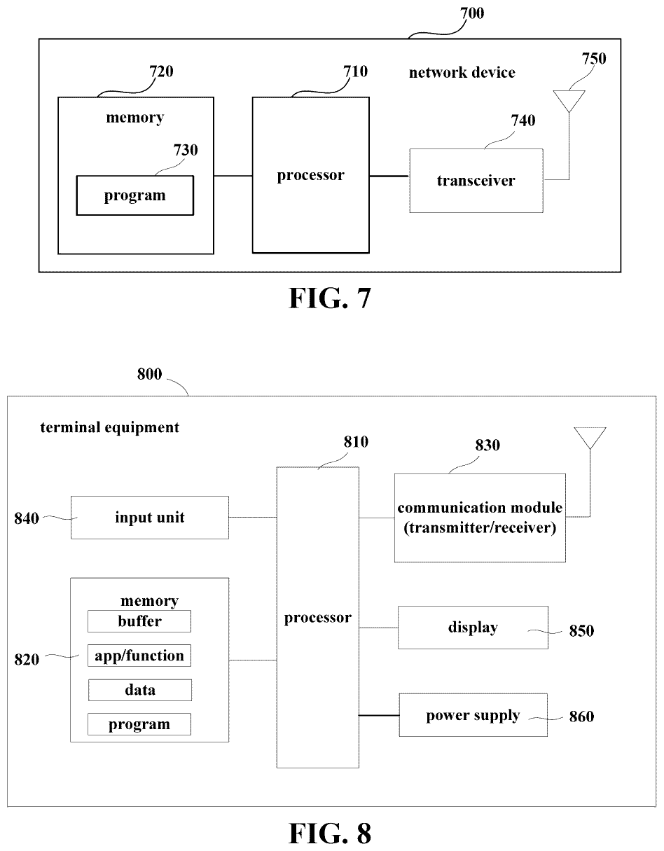

FIG. 7 is a schematic diagram of composition of the network device in the embodiments of the present application. As shown in FIG. 7, a network device 700 may include a processor 710 (such as a central processing unit (CPU)) and a memory 720; the memory 720 is coupled to the processor 710. The memory 720 may store various data and also may store the information processing program 730, and the program 730 is executed under the control of the processor 710.

In addition, as shown in FIG. 7, the network device 700 may further include: a transceiver 740 and an antenna 750, etc., wherein the functions of the above components are similar to the related art, and will not be repeated here. It is worth noting that the network device 700 is not necessarily required to include all of the components shown in FIG. 7; in addition, the network device 700 may further include components not shown in FIG. 7, with reference to the related art. The embodiments of the present application further provide a terminal equipment, but which is not limited in the present application, and may also be other devices.

FIG. 8 is a schematic diagram of a terminal equipment in the embodiments of the present application. As shown in FIG. 8, the terminal equipment 800 may include a processor 810 and a memory 820; the memory 820 stores data and program, and is coupled to the processor 810. It is worth noting that this figure is exemplary; other types of structures may also be used in addition to or instead of the structure to implement telecommunications functions or other functions.

For example, the processor 810 may be configured to execute the program to implement the packet data convergence protocol (PDCP) entity establishment method as described in the embodiments of the first aspect. For example, the processor 1810 may be configured to perform the following controls of: mapping a QoS flow to at least one DRB, wherein the QoS flow includes at least one sub QoS flow, and the one sub QoS flow corresponds to the one DRB; establishing at least one corresponding PDCP entity for the at least one DRB, wherein the at least one PDCP entity shares the first information.

As shown in FIG. 8, the terminal equipment 800 may further include a communication module 830, an input unit 840, a display 850, and a power supply 860. The functions of the above components are similar to the related art, and will not be repeated here. It is worth noting that the terminal equipment 800 is not necessarily required to include all of the components shown in FIG. 8, and the above components are not essential; in addition, the terminal equipment 800 may further include components not shown in FIG. 8, with reference to the related art.

The embodiments of the present application further provide a computer program which, when being executed in the terminal equipment, causes the terminal equipment to execute the packet data convergence protocol (PDCP) entity establishment method described in the embodiments of the first aspect.

The embodiments of the present application further provide a storage medium storing a computer program which causes the terminal equipment to execute the packet data convergence protocol (PDCP) entity establishment method described in the embodiments of the first aspect.

The embodiments of the present application further provide a computer program which, when being executed in the terminal equipment, causes the terminal equipment to execute the packet data convergence protocol (PDCP) entity indication method described in the embodiments of the second aspect.

The embodiments of the present application further provide a storage medium storing a computer program which causes the terminal equipment to execute the packet data convergence protocol (PDCP) entity indication method described in the embodiments of the second aspect.

The above devices and methods of the present application can be implemented by hardware or by hardware combined with software. The present application relates to a computer readable program which, when being executed by a logic unit, enables the logic unit to implement the devices or components mentioned above, or enables the logic unit to implement the methods or steps described above. The present application also relates to storage medium for storing the above programs, such as a hard disk, a magnetic disk, a compact disc, a DVD, a flash memory, etc.

The method/device described in conjunction with the embodiments of the present application may be directly embodied as hardware, a software module executed by the processor, or a combination of both. For example, one or more of the functional block diagrams and/or combination thereof shown in the drawing may correspond to both software modules and hardware modules of the computer program flow. These software modules can correspond to the steps shown in the drawings respectively. These hardware modules can be realized, for example, by solidifying these software modules using field programmable gate arrays (FPGA).

The software module may reside in an RAM memory, a flash memory, an ROM memory, an EPROM memory, an EEPROM memory, a register, a hard disk, a removable disk, a CD-ROM, or a storage medium in any other form known in the art. A storage medium can be coupled to a processor so that the processor can read information from the storage medium and write information to the storage medium; or the storage medium can be a constituent part of the processor. The processor and the storage medium can be located in the ASIC. The software module can be stored in the memory of the mobile terminal or in a memory card that can be inserted into the mobile terminal. For example, if a device (such as a mobile terminal) uses a large-capacity MEGA-SIM card or a large-capacity flash memory device, the software module can be stored in the MEGA-SIM card or the large-capacity flash memory device.

One or more of the functional blocks and/or combination thereof shown in the drawing may be implemented as a general-purpose processor, a digital signal processor (DSP), an application-specific integrated circuit (ASIC), a field programmable gate array (FPGA) or other programmable logic device, a discrete gate or a transistor logic device, a discrete hardware component, or any appropriate combination thereof, for performing the functions described in the present application. One or more of the functional blocks and/or combination thereof shown in the drawing may also be implemented as combination of computing devices, such as combination of DSP and a microprocessor, multiple microprocessors, one or more microprocessors combined with DSP communication, or any other such configuration.

The present application is described in combination with specific embodiments hereinabove, but a person skilled in the art should know clearly that the description is exemplary, but not limitation to the protection scope of the present application. A person skilled in the art can make various variations and modifications to the present application according to spirit and principle of the application, and these variations and modifications should also be within the scope of the present application.

For implementation including the above embodiments, the following supplements are further disclosed:

1. A packet data convergence protocol (PDCP) entity establishment method, wherein the method includes:
mapping a QoS flow to at least one DRB, wherein the QoS flow includes at least one sub QoS flow, and the one sub QoS flow corresponds to the one DRB;
establishing at least one corresponding PDCP entity for the at least one DRB, wherein the at least one PDCP entity shares the first information.

2. The method according to the supplement 1, wherein the PDCP entity includes a receiving PDCP entity and a transmitting PDCP entity.

3. The method according to the supplement 2, wherein the first information includes at least one of the following:
a transmitting buffer and a sequence number;
a receiving buffer, reordering and duplicate discarding;
a first timer (t-Reordering);
a reception state variable; or,
a transmission state variable.

4. The method according to the supplement 3, wherein the method further includes: determining the first information to which the QoS flow corresponds according to the first indication information.

5. The method according to the supplement 4, wherein the first indication information includes an identity of the QoS flow (QFI) to which the at least one sub QoS flow belongs.

6. The method according to the supplement 4, wherein the reception state variable to which the QoS flow corresponds includes:
a first reception state variable which indicates a COUNT value of next PDCP SDU expected to be received in the at least one PDCP entity; and/or
a second reception state variable which indicates a count value of a first PDCP SDU of the at least one PDCP entity that has not been delivered to an upper layer but is still waiting for being transmitted; and/or
a third reception state variable which indicates next COUNT value of the COUNT value associated with the PDCP data PDU in at least one PDCP entity that triggers a first timer (t-Reordering) corresponding to the QoS flow.

7. The method according to the supplement 4, wherein the transmission state variable to which the QoS flow corresponds includes:
a first transmission state variable indicating a count value of a PDCP SDU to be transmitted next in the at least one PDCP entity.

8. The method according to the supplement 7, wherein the at least one PDCP entity associates the count value of the PDCP SDU with the first transmission state variable.

9. The method according to the supplement 8, wherein the method further includes:
encrypting the PDCP data PDU to which the PDCP SDU corresponds by using the first transmission state variable,
wherein the sequence number of the PDCP data PDU is set to be modulo division of the first transmission state variable by 2\hat{ }[pdcp-SN-SizeUL]; where, pdcp-SN-SizeUL is a bit length of the sequence number; and
adding 1 to a value of the first transmission state variable.

10. The method according to the supplement 4, wherein establishing at least one corresponding PDCP entity for at least one DRB includes at least one of the following:
the upper layer requests the PDCP entity to be established;
the upper layer requests the PDCP entity to be re-established; or
the upper layer requests the PDCP entity to be suspended.

11. The method according to the supplement 10, wherein in the case where establishing at least one corresponding PDCP entity for at least one DRB includes that the upper layer requests the PDCP entity to be established:
in a case where the at least one PDCP entity establishes a first PDCP entity for the QoS flow, the transmission state variable and the reception state variable of the first PDCP entity are set to be of initial values.

12. The method according to the supplement 10, wherein in the case where establishing at least one corresponding PDCP entity for at least one DRB includes that the upper layer requests the PDCP entity to be re-established: for DRB in an unacknowledged Mode,
in a case where the DRB in the unacknowledged mode is a unique DRB of the QoS flow, the transmission state variable and/or the first reception state variable and/or the second reception state variable to which the QoS flow corresponds is/are set to be of an initial value/initial values; and/or
in the case where the first timer (t-Reordering) to which the QoS flow corresponds is running and where the DRB in the unacknowledged mode is a unique DRB of the QoS flow, the first timer (t-Reordering) to which the QoS flow corresponds is stopped and reset.

13. The method according to the supplement 10, wherein in the case where establishing at least one corresponding PDCP entity for at least one DRB includes that the upper layer requests the PDCP entity to be suspended:
in the case where the at least one PDCP entity has only one PDCP entity or where all of the at least one PDCP entity is suspended, the transmission state variable and/or the first reception state variable and/or the second reception state variable to which the QoS flow corresponds is/are set to be of an initial value/initial values; and/or
in the case where the first timer (t-Reordering) to which the QoS flow corresponds is running and where the at least one PDCP entity has only one PDCP entity, the first timer (t-Reordering) to which the QoS flow corresponds is stopped and reset.

14. The method according to the supplement 4, wherein the method further includes: configuring group information of the PDCP entity by using RRC signaling and the first indication information.

15. The method according to the supplement 14, wherein configuring group information of the PDCP entities by using RRC signaling and the first indication information includes:
newly adding a first field to the RRC signaling to indicate the first indication information, in a case where the first field is present, the first information to which the QoS flow corresponds is determined according to the first indication information.

16. The method according to the supplement 14, wherein the method further includes:
the RRC signaling is further used to configure second information corresponding to the first indication information, wherein the second information includes an initial value of the first timer (t-Reordering) and/or a bit length of the sequence number;
wherein the RRC signaling is used to configure identical second information for the at least one PDCP entity.

17. The method according to any of the supplements 1 to 16, wherein the method further includes:

at least one PDCP entity runs the same first timer (t-Reordering) at the same moment.

18. The method according to any of the supplements 1 to 17, wherein the method further includes:
establishing at least one corresponding PDCP entity for the at least one DRB in a newly added first sublayer, wherein the first sublayer contains the first information.

19. A packet data convergence protocol (PDCP) entity indication method, wherein the method includes:
transmitting first indication information, wherein the first indication information includes an identity of a QoS flow (QFI) to which a sub QoS flow belongs,
wherein the QoS flow is mapped to at least one DRB, the one QoS flow includes the at least one sub QoS flow, and the one sub QoS flow corresponds to one DRB.

20. The method according to the supplement 19, wherein the method further includes:
transmitting the RRC signaling, and configuring group information of the PDCP entity by using RRC signaling and the first indication information.

21. The method according to the supplement 20, wherein configuring group information of the PDCP entities by using RRC signaling and the first indication information includes:
newly adding a first field to the RRC signaling to indicate the first indication information, in a case where the first field is present, the first information to which the QoS flow corresponds is determined according to the first indication information.

22. The method according to the supplement 21, wherein the first information includes at least one of the following:
a transmitting buffer and a sequence number;
a receiving buffer, reordering and duplicate discarding;
a first timer (t-Reordering);
a reception state variable; or,
a transmission state variable.

23. The method according to the supplement 20, wherein the method further includes:
the RRC signaling is further used to configure second information corresponding to the first indication information, wherein the second information includes an initial value of the first timer (t-Reordering) and/or a bit length of the sequence number,
wherein the RRC signaling is used to configure identical second information for the at least one PDCP entity.

24. A terminal equipment including a memory storing a computer program and a processor configured to execute the computer program to implement the packet data convergence protocol (PDCP) entity establishment method according to any of the supplements 1 to 18.

25. A network device including a memory storing a computer program and a processor configured to execute the computer program to implement the packet data convergence protocol (PDCP) entity indication method according to any of the supplements 19 to 23.

26. A communication system including:
a network device configured to transmit first indication information, wherein the first indication information includes an identity of a QoS flow (QFI) to which a sub QoS flow belongs, wherein the QoS flow is mapped to at least one DRB, the one QoS flow includes the at least one sub QoS flow, and the one sub QoS flow corresponds to one DRB;
a terminal equipment configured to map a QoS flow to at least one DRB, wherein the QoS flow includes at least one sub QoS flow, and the one sub QoS flow corresponds to the one DRB;
establish at least one corresponding PDCP entity for the at least one DRB, wherein the at least one PDCP entity shares the first information.

What is claimed is:

1. An apparatus, configured in a terminal equipment for packet data convergence protocol (PDCP) entity establishment, the apparatus comprising:
processor circuitry configured to
map at least one group of Protocol Data Unit (PDU) Sets to at least one data radio bearer; and
establish at least one corresponding packet data convergence protocol (PDCP) entity for the at least one data radio bearer, wherein the at least one packet data convergence protocol (PDCP) entity shares first information.

2. The apparatus according to claim 1, wherein the packet data convergence protocol (PDCP) entity comprises a receiving packet data convergence protocol (PDCP) entity and a transmitting packet data convergence protocol (PDCP) entity.

3. The apparatus according to claim 2, wherein the first information comprises at least one of the following:
a transmitting buffer and a sequence number;
a receiving buffer, reordering and duplicate discarding;
a first timer;
a reception state variable; or,
a transmission state variable.

4. The apparatus according to claim 3, wherein the processor circuitry is configured to determine the first information to which a quality of service (QOS) flow corresponds according to first indication information.

5. The apparatus according to claim 4, wherein the first indication information comprises an identity of the quality of service (QOS) flow to which the at least one sub-quality of service (QOS) flow belongs.

6. The apparatus according to claim 4, wherein the reception state variable to which the quality of service (QOS) flow corresponds comprises:
a first reception state variable indicating a count value of a packet data convergence protocol service data unit (PDCP SDU) expected to be received next by the at least one packet data convergence protocol (PDCP) entity; and/or
a second reception state variable indicating a count value of a first packet data convergence protocol service data unit (PDCP SDU) of the at least one PDCP entity that has not been delivered to an upper layer but is still waiting for being transmitted; and/or
a third reception state variable indicating a count value next to a count value associated with a packet data convergence protocol (PDCP) data protocol data unit (PDU) in the at least one packet data convergence protocol (PDCP) entity triggering the first timer to which the quality of service (QoS) flow corresponds.

7. The apparatus according to claim 4, wherein the transmission state variable to which the quality of service (QOS) flow corresponds comprises:
a first transmission state variable indicating a count value of a packet data convergence protocol service data unit (PDCP SDU) to be transmitted next in the at least one packet data convergence protocol (PDCP) entity.

8. The apparatus according to claim 7, wherein the at least one packet data convergence protocol (PDCP) entity associates the count value of the packet data convergence protocol service data unit (PDCP SDU) with the first transmission state variable.

9. The apparatus according to claim 8, wherein the processor circuitry is further configured to:
encrypt the packet data convergence protocol (PDCP) data protocol unit (PDU) to which the packet data convergence protocol service data unit (PDCP SDU) corresponds by using the first transmission state variable, wherein the sequence number of the packet data convergence protocol (PDCP) data protocol unit (PDU) is set to be modulo division of the first transmission state variable by 2\hat{ }[pdcp-SN-SizeUL], where, pdcp-SN-SizeUL is a bit length of the sequence number; and
add 1 to a value of the first transmission state variable.

10. The apparatus according to claim 4, wherein the processor circuitry is configured to establish at least one corresponding data radio bearer for the at least one packet data convergence protocol (PDCP) entity comprises at least one of the following:
an upper layer requests the packet data convergence protocol (PDCP) entity to be established;
an upper layer requests the packet data convergence protocol (PDCP) entity to be re-established; or,
an upper layer requests the packet data convergence protocol (PDCP) entity to be suspended.

11. The apparatus according to claim 10, wherein in a case where the establishing at least one corresponding data radio bearer for the at least one packet data convergence protocol (PDCP) entity comprises the upper layer requests the packet data convergence protocol (PDCP) entity to be established,
in a case where the at least one packet data convergence protocol (PDCP) entity establishes a first packet data convergence protocol (PDCP) entity for the quality of service (QOS) flow, the transmission state variable and the reception state variable of the first packet data convergence protocol (PDCP) entity are set to be of initial values.

12. The apparatus according to claim 10, wherein in a case where the establishing at least one corresponding data radio bearer for the at least one packet data convergence protocol (PDCP) entity comprises the upper layer requests the packet data convergence protocol (PDCP) entity to be re-established, for a data radio bearer in an unacknowledged mode,
in a case where the data radio bearer in the unacknowledged mode is a unique data radio bearer of the quality of service (QOS) flow, the transmission state variable and/or a first reception state variable and/or a second reception state variable to which the quality of service (QOS) flow corresponds is/are set to be of an initial value/initial values; and/or
in a case where the first timer to which the quality of service (QOS) flow corresponds is running and the data radio bearer in the unacknowledged mode is a unique data radio bearer of the quality of service (QOS) flow, the first timer to which the quality of service (QOS) flow corresponds is stopped and reset.

13. The apparatus according to claim 10, wherein in a case where the establishing at least one corresponding data radio bearer for the at least one packet data convergence protocol (PDCP) entity comprises the upper layer requests the packet data convergence protocol (PDCP) entity to be suspended,
in a case where there is only one packet data convergence protocol (PDCP) entity in the at least one packet data convergence protocol (PDCP) entity, or in a case where all the at least one PDCP entity is suspended, the transmission state variable and/or a first reception state variable and/or a second reception state variable to which the quality of service (QOS) flow corresponds is/are set to be of an initial value/initial values; and/or
in a case where the first timer to which the quality of service (QOS) flow corresponds is running and there is only one packet data convergence protocol (PDCP) entity in the at least one packet data convergence protocol (PDCP) entity, the first timer to which the quality of service (QoS) flow corresponds is stopped and reset.

14. The apparatus according to claim 4, the apparatus further comprising:
a receiver configured to receive radio resource control (RRC) signaling,
wherein the radio resource control (RRC) signaling and the first indication information are used to configure group information of the packet data convergence protocol (PDCP) entity.

15. The apparatus according to claim 14, wherein that the radio resource control (RRC) signaling and the first indication information are used to configure group information of the packet data convergence protocol (PDCP) entity comprises:
newly adding a first field to the radio resource control (RRC) signaling to indicate the first indication information, in a case where the first field is present, determining the first information to which the quality of service (QOS) flow corresponds according to the first indication information.

16. The apparatus according to claim 14, wherein,
the radio resource control (RRC) signaling is further used to configure second information corresponding to the first indication information, wherein the second information comprises an initial value of the first timer and/or a bit length of the sequence number,
wherein the radio resource control (RRC) signaling is used to configure identical second information for the at least one packet data convergence protocol (PDCP) entity.

17. The apparatus according to claim 4, wherein the at least one packet data convergence protocol (PDCP) entity runs the same first timer at the same time.

18. The apparatus according to claim 1, wherein the processor circuitry is configured to established at least one corresponding packet data convergence protocol (PDCP) entity for the at least one data radio bearer in a first sublayer which is newly added, wherein the first sublayer comprises the first information.

19. An apparatus configured in a network device for indicating packet data convergence protocol (PDCP) entity, the apparatus comprising:
a transmitter configured to transmit first indication information, wherein the first indication information comprises an identity of a quality of service (QOS) flow to which a sub-quality of service (QOS) flow belongs,
wherein a quality of service (QOS) flow is mapped to at least one data radio bearer, the quality of service (QOS) flow comprising at least one sub-quality of service (QOS) flow, the sub-quality of service (QOS) flow corresponding to a data radio bearer.

20. The apparatus according to claim 19, wherein the transmitter is further configured to transmit radio resource control (RRC) signaling, wherein the radio resource control (RRC) signaling and the first indication information are used to configure group information of the packet data convergence protocol (PDCP) entity.
